(19) United States
(12) Patent Application Publication
(10) Pub. No.: US 2024/0344159 A1
(43) Pub. Date: Oct. 17, 2024

(54) PROCESS FOR MANUFACTURING VEHICLE PARTS

(71) Applicant: MAGNA INTERNATIONAL INC., Aurora (CA)

(72) Inventor: Alejandro Gorráez ALEJANDRE, San Andrés Cholula Puebla (MX)

(21) Appl. No.: 18/681,602

(22) PCT Filed: Aug. 17, 2022
(86) PCT No.: PCT/CA2022/051248

§ 371 Date: Feb. 6, 2024

Related U.S. Application Data
(60) Provisional application No. 63/236,327, filed on Aug. 24, 2021.

(51) Int. Cl. C21D 1/673; C21D 1/18; C21D 1/42; C21D 7/10; C21D 8/00

(52) U.S. Cl. CPC C21D 1/673; C21D 1/18; C21D 1/42; C21D 7/10; C21D 8/005; C21D 2211/008; C21D 2261/00

(57) ABSTRACT

A process for manufacturing a vehicle part from steel material, such as Mn22B5 steel material, using a single transfer press is provided. The process includes stamping, trimming, and piercing the steel material in the transfer press at room temperature, before the steel material is heated. The process then includes induction heating of the stamped steel material in the same press to form austenite in the steel material. After the induction heating, the process includes rapid quenching of the steel material in the same press to form martensite in the steel material. The process does not require an oven to heat the steel material prior to stamping and does not require laser machines for the trimming and piercing. The steel material does not need to be transferred to multiple different locations, which contributes to the improved productivity of the process compared to conventional hot stamping processes.

### CROSS-REFERENCE TO RELATED APPLICATION

This PCT International Patent Application claims the benefit of U.S. Provisional Patent Application Ser. No. 63/236,327 filed on Aug. 24, 2021 titled “Process For Manufacturing Vehicle Parts,” the entire disclosure of which is hereby incorporated by reference.

### BACKGROUND OF THE INVENTION

### 1. Field of the Invention

The invention relates generally to a process for manufacturing vehicle parts, such as vehicle parts formed of steel.

### 2. Related Art

Hot stamping is a common process used to form steel into various parts for vehicles. The hot stamping process typically includes heating the steel material to a temperature of at least 900° C. in an oven or furnace, and then quickly transferring the steel material to a separate hot stamping press with a die to form the steel material into a desired shape. After the steel material is formed, the formed steel material is also quenched in the die. For example, Mn22B5 grade steel is typically quenched at a rate of about 27° C. per second. After the quenching step, the formed steel material is preferably transferred from the die to another location where it is trimmed and/or pierced to form the desired shape of the vehicle part. Lasers are typically used for trimming and piercing the steel material to achieve the desired shape.

Current hot stamping processes require both the press and separate laser machines to form, trim, and pierce the steel material. The current hot stamping process is also time consuming due to the quenching step. Thus, increased productivity of the hot stamping process is desired.

### SUMMARY OF THE INVENTION

One aspect of the invention provides a process for manufacturing vehicle parts comprising the steps of: stamping a steel material in a press before the steel material is heated; optionally piercing and/or trimming the stamped steel material in the press before the steel material is heated; induction heating the stamped steel material in the press; and quenching the stamped steel material in the press after the induction heating.

Another aspect of the invention provides a vehicle part formed by stamping a steel material in a press before the steel material is heated; optionally piercing and/or trimming the stamped steel material in the press before the steel material is heated; induction heating the stamped steel material in the press; and quenching the stamped steel material in the press after the induction heating.

### BRIEF DESCRIPTION OF THE DRAWING

Other advantages of the present invention will be readily appreciated, as the same becomes better understood by reference to the following detailed description when considered in connection with the accompanying drawing wherein:

FIG. 1 illustrates a process for manufacturing vehicle parts which occurs in a single press according to an example embodiment of the invention.

### DESCRIPTION OF THE ENABLING EMBODIMENT

One aspect of the invention provides a process for manufacturing vehicle parts, specifically vehicle parts formed of a steel material, with increased productivity, compared to conventional hot stamping processes. The entire process can be conducted in a single transfer press with the same die set, for example a conventional transfer press, which contributes to the increased productivity. The transfer press is also referred to as a forming press.

According to an example embodiment, the vehicle parts are formed from Mn22B5 grade steel material, but other types of steel material can be used. The method includes stamping the steel material in the press before any heating of the steel material. The steel material is typically at room temperature and is preferably slightly soft during the stamping step. The steel material is typically at a temperature of not greater than 50° C. during the stamping step. The stamping step can include multiple stages, such as pressing, drawing, and/or other forming operations. The method also preferably includes trimming and/or piercing the steel material in the press before any heating of the steel material. The steel material is typically at room temperature and is preferably slightly soft during the trimming and/or piercing step. The steel material is typically at a temperature of not greater than 50° C. during the trimming and/or piercing step.

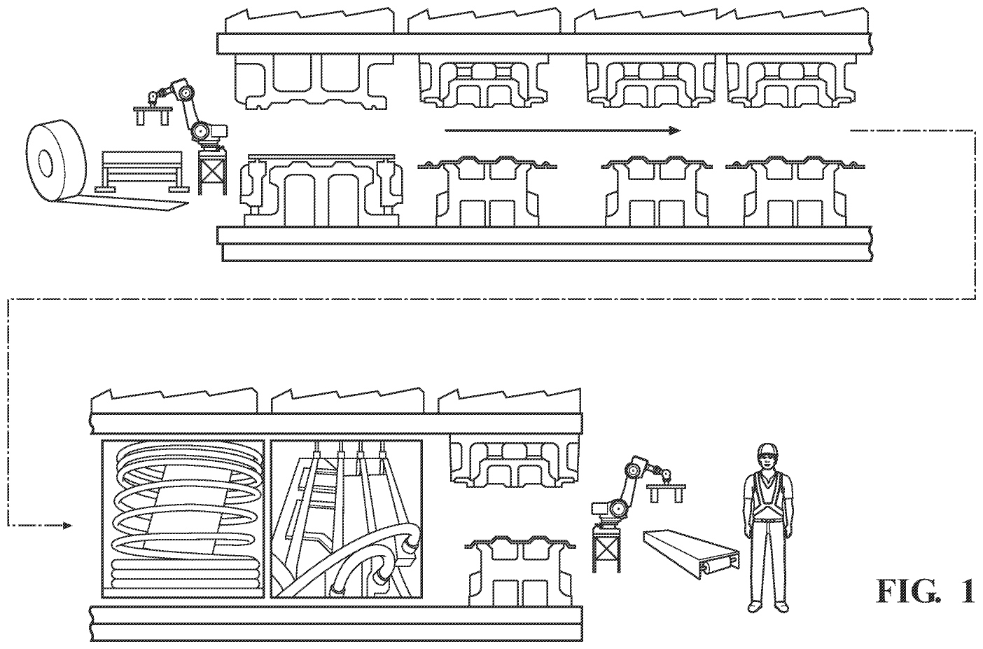

The stamping, piercing, and trimming steps are conducted in the single transfer press, but these steps can occur at multiple stations within the same die set. In the example embodiment shown in FIG. 1, the process includes drawing the steel material at a first forming station, specifically with conventional cold stamping draw dies. The process next includes trimming the steel material at a second forming station after the drawing step, followed by trimming and piercing the steel material at third and fourth forming stations. The trimming and piercing steps are conducted with conventional cold trimming and piercing dies.

After the cold stamping, trimming and/or piercing steps, the process includes heating the steel material by induction heating in the same transfer press. The induction heating step can include multiple stages and/or occur at multiple stations. According to the example embodiment, the heating step includes induction heating the stamped steel material from room temperature to 500° C. at a first heating station, induction heating the steel material from 500 to 750° C. at a second heating station, and induction heating the steel material from 750 to 900° C. at a third heating station. According to the example embodiments, the heating step forms austenite in the steel material.

After the heating step, the process includes quenching of the heated steel material in the same transfer press. According to an example embodiment, the quenching step includes cooling the steel material directly with water at a rate of about 100° C. per second. According to the example embodiment, the temperature of the steel material is reduced from 800° C. to 200° C. in an average of 6 seconds. Preferably, a lower die of the hot forming process conducts a rapid quench. The rapid quench process includes water in direct contact with the steel material to be cooled down. Thus, the lower die is a shower type die that provides the water and allows water to contact the formed steel material to enable the rapid quenching. The upper die includes a standard cooling technique used in hot stamping dies. The standard cooling technique includes circulating water inside of the upper die, which cools down the upper die and thus cools down the steel material which is in contact with the upper die. This indirect cooling technique can take longer than the rapid quench.

Both the upper and lower dies preferably include floating punches, binders, and cavities, to increase the time that the steel material will be in contact with the dies during the cooling step. The purpose of the floating punches is to increase contact time with the steel material to be cooled down. The floating binders are extended by nitrogen cylinders, and when the steel material is set inside the dies, the floating binders hold the steel material and then allow the steel material to be cooled down even though the transfer press is not at BDC (bottom dead center), thus increasing the time that the binders have in between the steel material to be cooled down. According to the example embodiments, the quenching step forms martensite in the steel material.

The process for manufacturing the vehicle part according to the invention is more productive than conventional hot stamping processes used to form vehicle parts. Current hot stamping processes require an oven to heat the steel material, separate stamping press to hot stamp the steel material, and then separate laser machines to trim and pierce the steel material after the heating and stamping steps. The steel material must be transferred between multiple locations to complete the process, which increases the duration and cost of the process. The traditional quenching step is time consuming due to the indirect heat dissipation.

The process of the present invention eliminates the use of any oven to heat the steel material before stamping, which reduces the total amount of space needed to form the vehicle part, compared to the conventional hot stamping processes. The process of the present invention also does not require a laser machine to trim and pierce the steel material. The process of the present invention also requires less cycle time, compared to the conventional hot stamping processes.

The process according to the invention can be used to form various types of vehicle parts. Example vehicle parts include a body-in-white part, pillar, rocker, column, beam, rail, reinforcement, and bumper.

Obviously, many modifications and variations of the present invention are possible in light of the above teachings and may be practiced otherwise than as specifically described while within the scope of the following claims.

1. A process for manufacturing a vehicle part, comprising the steps of:
stamping a steel material in a press before the steel material is heated;
induction heating the stamped steel material in the press; and
quenching the stamped steel material in the press after the induction heating.

2. The process according to claim 1 including piercing and/or trimming the stamped steel material before the steel material is heated.

3. The process according to claim 2, wherein the stamping, piercing, and/or trimming steps are conducted while the steel material is at a temperature of not greater than 50° C.

4. The process according to claim 1, wherein the stamping step includes drawing the steel material.

5. The process according to claim 4, wherein the drawing step occurs at a first forming station, and further including trimming the steel material at a second forming station in the press after the drawing step and before heating the steel material.

6. The process according to claim 5 further including trimming the steel material at a third forming station in the press after the trimming step at the second forming station, and piercing the steel material at a fourth forming station in the press after the trimming step at the third forming station.

7. The process according to claim 1, wherein the induction heating step includes induction heating the stamped steel material from room temperature to 500° C. at a first heating station in the press, induction heating the steel material from 500 to 750° C. at a second heating station in the press, and induction heating the steel material from 750 to 900° C. at a third heating station in the press.

8. The process according to claim 1, wherein the quenching step includes cooling the steel material directly with water at a rate of about 100° C. per second.

9. The process according to claim 1, wherein the induction heating step includes heating the steel material to a temperature of 900° C., and the quenching step includes reducing the temperature of the steel material from 800° C. to 200° C. in 6 seconds.

10. The process according to claim 1, wherein the quenching step includes directly contacting the steel material with water provided from a lower die of the press, and the quenching step includes circulating water through an upper die which is in contact with the steel material.

11. The process according to claim 1, wherein the press includes upper and lower dies to conduct the quenching step, and the upper and lower dies include floating punches.

12. The process according to claim 1, wherein the press includes upper and lower dies to conduct the quenching step, the upper and lower dies include floating binders, the floating binders are extended by nitrogen cylinders, and when the steel material is disposed between the dies, the floating binders hold the steel material and allow the steel material to be cooled down even when the transfer press is not at BDC (bottom dead center).

13. The process according to claim 1, wherein the press includes upper and lower dies to conduct the quenching step, and the upper and lower dies include cavities.

14. The process according to claim 1, wherein the press is a conventional transfer press.

15. The process according to claim 1, wherein the induction heating includes forming austenite in the steel material, and the quenching step includes forming martensite in the steel material.

16. The process according to claim 1, wherein the steel material is Mn22B5 grade steel.

17. The process according to claim 1, wherein the vehicle part is a body-in-white part, pillar, rocker, column, beam, rail, reinforcement, or bumper.

18. A part formed of a steel material for a vehicle manufactured by the process of claim 1.

19. The part according to claim 18, wherein the part is formed of steel and is a body-in-white part, pillar, rocker, or column.

20. The part according to claim 18, wherein the part is formed of steel and is a beam, rail, reinforcement, or bumper.
